(19) United States
(12) Patent Application Publication
(10) Pub. No.: US 2008/0061068 A1
(43) Pub. Date: Mar. 13, 2008

(54) Teflon-Coated Cooking Utensil

(76) Inventors: Michel Fontaine, Sales (FR); Laurent Voisin, Sales (FR); Claudine Gardaz, Rumilly (FR)

Correspondence Address: BACHMAN & LAPOINTE, P.C., 900 CHAPEL STREET, SUITE 1201, NEW HAVEN, CT, 06510, US

(21) Appl. No.: 11/660,779

(22) PCT Filed: Aug. 24, 2005
(86) PCT No.: PCT/FR05/02136

§ 371 Date: Sep. 28, 2007

(30) Foreign Application Priority Data
Aug. 24, 2004 (FR) 0409057

(51) Int. Cl. A47J 27/00

(52) U.S. Cl. 220/573.2; 220/573.3

(57) ABSTRACT

A cooking utensil has a teflon-coated metal support which coating is designed to form at least the inner surface of the cooking utensil and comprises at least one layer, which layer includes a fluorocarbon resin, alone or mixed with a second heat-stable resin resistant to at least 200° C. The at least one layer comprises a mineral compound resistant to temperatures higher than the sintering temperature of the resin(s) and has antimicrobial properties.

### BACKGROUND

The present invention relates to a cooking utensil such as a frying pan, a sauce pan, a stew pan, including an anti-adhesive coating.

This anti-adhesive coating, which should have excellent anti-adherence, is currently intended to form at least the inner surface of the cooking utensil so as to allow foodstuffs to be cooked while minimizing at most risks of having the foodstuffs stick and to provide optimum and easy cleaning of the cooking utensil after use.

Such an anti-adhesive coating generally comprises at least one layer based on heat-stable resin resistant to at least 200° C., this heat-stable resin conventionally comprising a fluorocarbon resin either alone or mixed with one or more other heat-stable resins which resist to at least 200° C.

This fluorocarbon resin may be polytetrafluoroethylene (PTFE), a copolymer of tetrafluoroethylene and perfluoroproylvinylether (PFA) or a copolymer of tetrafluoroethylene and hexafluoropropylene (FEP) or a mixture of these fluorocarbon resins.

The other heat-stable resins resistant to at least 200° C. may be a polyamide imide (PAI), a polyethylene sulfone (PES), polyphenylene sulphide (PPS), a polyetherketone (PEK), a polyetheretherketone (PEEK) or a silicone.

However, in spite of thorough domestic cleanings of this type of anti-adhesive coatings, growth of micro-organisms notably microbes and in particular bacteria, is observed at least at the surface of the anti-adhesive coating.

Growth of micro-organisms and their subsequent proliferation are explained by the presence of porosities in the coating based on fluorocarbon resin. Indeed, micro-organisms may develop from food residues, which have not been removed during the cleaning, and/or from stains, these residues and stains being housed in the porosities of the coating.

Growth of micro-organisms is still increased during repeated cycles of use of the cooking utensil, because of the wear of the coating, and notably because of the presence of scratches at its surface. Indeed, the scratches further increase the number of sites within which micro-organisms may develop.

If it is recognized that by cooking at high temperatures, of at least 150° C., most of these micro-organisms may be eliminated, this is not the case when heating up food to low temperatures or even when storing these same foodstuffs at low temperature or at room temperature, directly in the cooking utensil.

### SUMMARY OF THE INVENTION

The object of the present invention is therefore to find a remedy to the problem of development of micro-organisms within an anti-adhesive coating based on one or more fluorocarbon resins, of a cooling utensil, without however causing said anti-adhesive coating to lose its anti-adherence character and this, regardless of the conditions of use of the cooking utensil, whether for storing, heating up or even cooking foodstuffs.

The cooking utensil according to the invention comprises a metal support covered with an anti-adhesive coating, this coating being intended to form at least the inner surface of the cooking utensil and comprising at least one layer, said layer comprising a fluorocarbon resin, either alone or mixed with a second heat-stable resin which resists to at least 200° C.

According to the invention, said at least one layer comprises a mineral compound which resists to temperatures above the sintering temperature of the resin(s) and has anti-microbial properties by contact of the micro-organisms, possibly present on the anti-adhesive coating, either directly with the mineral compound or with the ions of said mineral and which are diffused by this compound, or by combined contact.

With the mineral compound according to the invention it is possible to impart sought-after anti-microbial properties for the anti-adhesive coating, without fundamentally changing the compositions conventionally used for making such anti-adhesive coatings.

Indeed, the mineral compound behaves like any other mineral filler such as strengthening fillers or pigments, without changing the anti-adhesive properties provided by the resin(s) forming the coating.

In particular, the methods for making cooking utensils are not challenged by the novel composition of the anti-adhesive coating.

Thus, in a quite conventional way, the mineral compound may be introduced in the dry condition, or as an aqueous dispersion, into the compositions of layers comprising at least the fluorocarbon resin. A homogeneous layer comprising a fluorocarbon resin and the mineral compound is thereby achieved.

### DETAILED DESCRIPTION OF THE PREFERRED EMBODIMENT(S)

The cooking utensil according to the invention comprises an anti-adhesive coating formed with at least one layer.

This layer comprises the mineral compound having anti-microbial properties as well as a fluorocarbon resin.

The fluorocarbon resin may comprise at least one compound selected from PTFE, PFA and FEP, currently used in the compositions of anti-adhesive coatings.

This layer may further also comprise a second heat-stable resin resistant to at least 200° C. and comprising at least one compound selected from PAI, PES, PPS, PEK, PEEK and silicone.

As the mineral compound is selected so to resist to temperatures above the sintering temperature of the resins applied in the anti-adhesive coating, its anti-microbial properties are kept intact not only after the sintering step, but also during subsequent cooking operations of the foodstuffs, performed by the user. This compound should at least resist, for a period of 10 minutes, to a cooking or sintering temperature of the order of 400-420° C.

It is specified that the mineral compound applied within the scope of the present invention should also resist to the cleaning products over time as well as to the different washing cycles in a dishwasher.

As this mineral compound is moreover present throughout the thickness of the layer forming the anti-adhesive coating, and not only at the surface, the anti-microbial activity of the coating is maintained even in the case of scratches and/or wear of the coating. Indeed, possible micro-organisms present in the porosities located in the anti-adhesive coating layer will necessarily come into contact with the anti-microbial mineral compound and/or with the ions which it may diffuse.

Of course, the mineral compound applied within the scope of the present invention should be compatible with use in food.

In an advantageous version of the invention, the mineral compound is a compound able to salt out silver ions.

Indeed, anti-microbial and bactericidal properties of silver are known, notably used in a medical environment and for cleansing.

However, the use of a mineral compound, such as one including silver, in the food industry field was hitherto only contemplated for containers consisting of this material or covered by the latter, but for uses at table and not in cooking, and anyhow not for their possible anti-microbial characteristics. Reference may also notably be made to regulatory provisions which define that water, in order to be described as “drinkable” should contain less than 10 μg/L of silver. Such low tolerance values have thereby always clearly dissuaded one skilled in the art from applying a mineral compound such as silver for a food application in cooking utensils to be heated.

The use of a mineral compound such as silver has thus never been contemplated for its anti-microbial properties in compositions of anti-adhesive coatings of cooling utensils used for heating up or cooking foodstuffs.

Surmounting this prejudice, the inventor in spite of this used a mineral compound containing silver in the composition of the layer forming an anti-adhesive coating for a utensil intended to be used for heating and/or cooking foodstuffs: he performed tests with very small weight contents, so that they have no toxicity for the user of cooking utensils covered with such a coating, which moreover is an unquestionable economic advantage.

Surprisingly, he was able to then notice that he obtained, in spite of this low weight content of mineral compound, very good results as regards reduction of micro-organisms, in particular in the case when said at least one layer forming the anti-adhesive coating comprises from 0.1 to 0.2% by weight of silver, after sintering.

A first anti-microbial mineral compound, particularly satisfactory with regards to the goal of the present invention, is a zirconium phosphate which satisfies the formula AgₓNa_{(1-x-y)}H_{y}Zr₂(PO₄)₃.

Such a mineral compound satisfying the above formula is notably marketed under the brand AlphaSan™ by Milliken.

This AlphaSan™ compound, which has a purity level greater than 99% as well as a heat stability above 1,000° C., is a white powder.

In order to minimize as least as possible the aspect of the final coating, which currently has a black and flaked aspect, the mineral compound of formula AgₓNa_{(1-x-y)}H_{y}Zr₂(PO₄)₃ comprising 10% by weight of silver will preferably be used. The latter is marketed today under reference RC 2000.

A second anti-microbial mineral compound also satisfactory with regards to the goal of the present invention is formed by a composite compound formed with a central core, for example titanium dioxide, covered with a silver layer.

A particular example of such a mineral compound is marketed under the brand MicroFree™ by Du Pont.

Incorporation of the mineral compound provided with anti-microbial properties may be carried out in the case of an anti-adhesive coating which only includes a single layer as described above.

Making an anti-adhesive layer having anti-microbial properties may therefore be carried out in a single step, by applying a homogeneous layer comprising a fluorocarbon resin and the anti-microbial mineral compound, the particles of this mineral compound being uniformly distributed in the thickness of the layer.

However, conventionally, anti-adhesive coatings of cooking utensils comprise at least one primary adhesion layer and at least one finishing layer, the primary adhesion and finishing layers being based on a fluorocarbon resin, possibly mixed with a heat-stable resin resistant to at least 200° C.

Reference will be made to the examples of fluorocarbon resin (PTFE, PFA and FEP) and heat-stable resins resistant to at least 200° C. (PAI, PES, PPS, PEK, PEEK and silicone) already mentioned above.

Thus, it is quite possible to contemplate a coating in which at least one primary adhesion layer comprises the mineral compound or even a coating in which at least one finishing layer comprises the mineral compound.

Other combinations may also be contemplated, by introducing the mineral compound provided with anti-microbial properties into the compositions of at least one primary layer and at least one finishing layer.

In the case when the mineral compound is incorporated into a primary adhesion layer and not in the finishing layer(s), its influence is considerably limited as to the colour of the final anti-adhesive coating, the latter however retaining its anti-microbial character.

The anti-adhesive coating according to the invention and therefore comprising the mineral compound may be applied to any cooking utensil, known for being covered with an anti-adhesive coating.

Not as a limitation, sauce pans, frying pans, cake pans, grill plates, fryers, pressure cookers or even stew pans will notably be mentioned.

1-10. (canceled)

11. A cooking utensil comprising a metal support covered with an anti-adhesive coating, said coating forming at least an inner surface of the cooking utensil, and coming into contact with foodstuffs in order to store the foodstuffs, heat the foodstuffs up or cook the foodstuffs in the utensil when the foodstuffs are placed therein, said inner surface comprising at least one layer which comprises a fluorocarbon resin, either alone or mixed with a second heat-stable resin resistant to at least 200° C., and said at least one layer further comprising a mineral compound which resists to temperatures above a sintering temperature of the resin(s) and has anti-microbial properties.

12. The cooking utensil according to claim 11, wherein the mineral compound is a compound able to salt out silver ions, which comprises from 0.1 to 0.2% by weight of silver after sintering.

13. The cooking utensil according to claim 12, wherein the mineral compound is a zirconium phosphate satisfying the formula AgₓNa_{(1-x-y)}H_{y}Zr₂(PO₄)₃.

14. The cooking utensil according to claim 13, wherein the mineral compound of formula AgₓNa_{(1-x-y)}H_{y}Zr₂(PO₄)₃ comprises 10% by weight of silver.

15. The cooking utensil according to claim 11, wherein the anti-adhesive coating comprises at least one primary adhesion layer, and at least a finishing layer, the primary adhesion and finishing layers being based on fluorocarbon resin, and at least one of the primary adhesion layer and the finishing layer comprises the mineral compound.

16. The cooking utensil according to claim 11, wherein the fluorocarbon resin comprises at least one compound selected from polytetrafluoroethylene (PTFE), tetrafluoroethylene and perfluoropropylvinylether copolymer (PFA) and tetrafluoroethylene and hexafluoro-propylene copolymer (FEP).

17. The cooking utensil according to claim 11, wherein the second heat stable resin resistant to at least 200° C. comprises at least one compound selected from a polyamide imide (PAI), a polyethylene sulfone (PES), a polyphenylene sulphide (PPS), a polyetherketone (PEK), a polyetheretherketone (PEEK) and a silicone.
